(19) United States
(12) Patent Application Publication
(10) Pub. No.: US 2020/0065591 A1
(43) Pub. Date: Feb. 27, 2020

(54) SYSTEM FOR THE MONITORING AND SECURITY OF THE ENVIRONMENT

(71) Applicant: EKIN TEKNOLOJl SANAYl VE TlCARET ANONlM SlRKETl, Istanbul (TR)

(72) Inventor: Akif EKIN, Sariyer/Istanbul (TR)

(73) Assignee: EKIN TEKNOLOJl SANAYl VE TlCARET ANONlM SlRKETl, Istanbul (TR)

(21) Appl. No.: 16/613,352

(22) PCT Filed: Dec. 15, 2017
(86) PCT No.: PCT/TR2017/000140

§ 371 Date: Nov. 13, 2019

(30) Foreign Application Priority Data
Feb. 17, 2017 (TR) 2017/02439

(51) Int. Cl. G06K 9/00; G06Q 50/30; G08G 1/017; G06K 9/32

(52) U.S. Cl. CPC G06K 9/00791; G06Q 50/30; G06K 2209/15; G06K 9/3258; G08G 1/0175

(57) ABSTRACT

The present invention relates to a system that enables the recognition of license plates, colors, faces and objects based on the data obtained by means of modules comprising visual and audio sensors that are disposed in taxis or mobile and immobile vehicles and objects that may continuously travel around in the city, the detection of incidents such as air pollution or explosions, and the generation of the 3D map of the city based on the visual and spatial data received from different modules. The system of the present invention comprises the user access device, the environment monitoring unit, the camera, the sensor unit, the wireless communication unit, the communication interface, the analysis unit, the image processing unit the detection unit, the data storage unit and the mapping unit.

### TECHNICAL FIELD

The present invention relates to a system that enables the recognition of license plates, colors, faces and objects based on the data obtained by means of modules comprising visual and audio sensors that are disposed in taxis or other types of mobile and immobile vehicles and objects that may continuously travel around in the city, the detection of incidents such as air pollution or explosions, and the generation of the 3D map of the city based on the visual and spatial data received from different modules.

### PRIOR ART

Nowadays, as a result of the increase in urban populations, security weaknesses cannot be prevented from occurring. Despite the advances in technology, a continuous monitoring cannot be possible in constantly growing cities. Even though an advanced level of monitoring can be realized in some regions, it is limited to those regions.

In addition, in the state of the art, security cameras that are installed in buildings or in certain critical areas in the city are used. However, said cameras monitor a fixed area, and, in case of an incident, are used as evidence after the incident. In some cases, said cameras are used for specific purposes such as detecting the license plate of a speeding car.

In another common practice in the state of the art, officers perform routine ID checks in order to find suspects. Performing these ID checks manually and randomly decreases the rate of success in identifying suspects.

Furthermore, since the monitoring devices such as cameras are usually immobile in state of the art embodiments, the area scanned is limited and the security can be provided for only a specific region, Therefore, an environmental security system that is mobile so as to reach every region in a city and that gathers necessary information to provide every kind of information for measures and solutions before and after an incident is needed.

In the state of the art United States Patent Document No. US2016132743, a portable device that performs license plate and face recognition functions is disclosed.

In the state of the art United States Patent Document No. US20140285523, a method that enables the digital photography content captured by the camera to be represented as a 3D virtual object by means of perspective information analysis is disclosed.

### BRIEF DESCRIPTION OF THE INVENTION

The aim of the present invention is the realization of a system that provides environmental monitoring by means of comprehensive and mobile units comprising audio, radiation and chemical gas sensing units, that perform the recognition of texts, license plates, faces and objects.

Another aim of the present invention is the realization of a system that enables the automatic detection of suspected individuals and their vehicles by means of facial recognition and license plate reading, and that generates an alarm signal to be sent to respective units.

Another aim of the present invention is the realization of a system that detects and records the texts on the objects in addition to the colors thereof by means of object recognition function, and that enables the user to perform searches based on time period, location, route, color and text.

Another aim of the present invention is the realization of a system that monitors incidents such as air pollution, chemical gas leakage, radiation and explosion and that generates an alarm warning the units in charge.

Another aim of the present invention is the realization of a system that is disposed on certain vehicles and objects so as to control the traffic flow rate, road condition, parking violations and the number of vehicles in traffic.

Another aim of the present invention is the realization of a system that enables the 3D city map to be generated by processing the city visuals and location data received from the modules disposed on more than one mobile vehicle.

### DETAILED DESCRIPTION OF THE INVENTION

“A System for the Monitoring and Security of the Environment” realized in order to attain the aim of the present invention is illustrated in the attached FIGURE, where

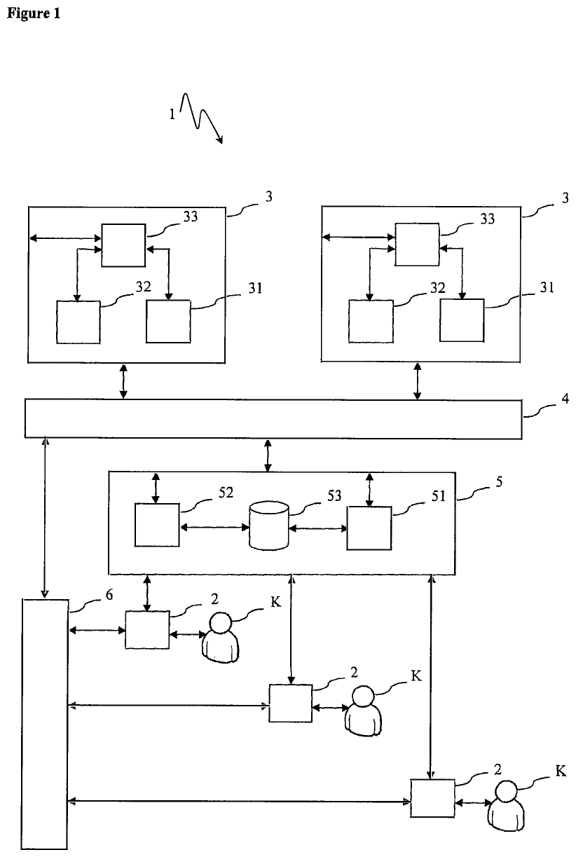

FIG. 1, schematic block diagram of the system according to the present invention.

The elements illustrated in the figures are numbered as follows:
1. System
2. User access device
3. Environment monitoring unit
31. Camera
32. Sensor unit
33. Wireless communication device
4. Communication interface
5. Analysis unit
51. Image processing unit
52. Detection unit
53. Data storage unit
6. Mapping unit
K: User

The system (1) of the present invention that provides environmental monitoring by means of comprehensive and mobile units that comprise audio, radiation and chemical gas sensing units and that perform the recognition of texts, license plates, colors and faces comprises
at least one user access device (2) in communication with the data network, with which the user (K) interacts,
at least one environment monitoring unit (3) disposed on the vehicles and objects for environmental monitoring and location detection and having at least one camera (31) that detects images, at least one sensor unit (32) with sensors thereon for measuring sounds, radiation, air pollution, chemical gasses, fog and weather conditions and at least one wireless communication device (33) for transmitting the data received from the camera (31) and the sensor unit (32) to corresponding units via a data network,
at least one communication interface (4) that receives the data by means of the wireless communication device (33) and categorizes the same so as to send each data to the corresponding unit for processing and that receives the data sent to be transmitted to the user access device (2) and transmits the same to the user access device (2) via a data network, at least one analysis unit (5) that processes the data transmitted by the communication interface (4) and that compares and stores the results,
at least one image processing unit (51) that is disposed in the analysis unit (5) and that executes the text, license plate, face and object recognition functions by processing the visual data received from the camera (31),
at least one detection unit (52) that is disposed in the analysis unit (5) and that analyzes the sensor data received from the sensor unit (32) and transmitted by the communication interface (4) based on the defined rules,
at least one data storage unit (53) that is disposed in the analysis unit (5) and that stores the data with which the analysis results will be compared and the comparison results, and
at least one mapping unit (6) that receives the digital data captured by the camera (31) and the location data from the communication interface (4) and that generates the 3D map of the city by processing the location information and the digital images received from different cameras. (FIG. 1)

The user access device (2) in the system of the present invention (1) is the unit with which the authorized users interact. The user access device (2) is in communication with a data network. The user access device (2) enables the data transmitted by the analysis unit (5) and the mapping unit (6) via the communication unit (4) to be displayed to the user (K) by means of a suitable interface. In an embodiment of the present invention, the user access device (2) displays to the user (K) the license plate, face and object recognition results transmitted by the image processing unit (51) disposed in the analysis unit (5). In an embodiment of the present invention, the user access device (2) displays to the user (K) the current or previous 3D map images transmitted by the mapping unit (6).

The environment monitoring unit (3) used in the system (1) of the present invention is the unit that collects data by means of the units contained therein. The environment monitoring unit (3) is disposed on a mobile or immobile vehicle or object and transmits the location data of the vehicle to the communication interface (4) in predetermined periods. The environment monitoring unit (3) comprises units for detecting the location information, and in one embodiment of the present invention, said location detection is performed by means of GPS (Global Positioning System). The environment monitoring unit (3) associates the data collected by the units contained therein with the location information detected by the environment monitoring unit (3) and transmits the data to the communication interface (4). The environment monitoring unit (3) further comprises RaDAR (Radio Detection and Ranging) units and LiDAR (Light Detection and Ranging) sensors. In an embodiment of the present invention, the environment monitoring unit (3) comprises 360 degree panoramic visual sensors.

The camera (31) disposed in the environment monitoring unit (3) captures the images of the environment. The environment monitoring unit (3) transmits the data generated by the camera (31) to the image processing unit (51) via the communication interface (4) for text, license plate, object and face recognition processes. The environment monitoring unit (3) associates the data generated by the camera (31) with the data received from the LiDAR sensors and sends the same to the mapping unit (6) together with the location information via the communication interface (4) for 3D mapping process.

The sensor unit (32) in the environment monitoring unit (3) enables the environmental conditions to be detected based on the data collected by means of the sensors in the sensor unit (32). The sensor unit (32) comprises audio, radiation, air pollution, chemical gas, fog and weather sensors. The environment monitoring unit (3) transmits the data collected by the sensor unit (32) together with the location information to the detection unit (52) by means of the communication interface (4).

The wireless communication device (33) in the environment monitoring unit (3) transmits the data received from the camera (31) and the sensor unit (32) to the communication interface (4) via a data network. The wireless communication device (33) transmits the location data detected by the environment monitoring unit (3) and RaDAR and LiDAR data to the communication interface (4).

The communication interface (4) used in the system (1) of the present invention transmits the data sent by the wireless communication device (33) disposed in the environment monitoring unit (3) to the corresponding units. The communication interface (4) transmits images captured by the camera (31) to image processing unit (51) in the analysis unit (5) together with the location data, and to the mapping unit (6) together with the LiDAR data and the location data. The communication interface (4) transmits the sensor data collected by the sensor unit (32) to the detection unit (52).

The analysis unit (5) in the system (1) of the present invention is the unit that assesses the data received from different units in the environment monitoring unit (3) based on predefined rules. The units in the analysis unit (5) processes the data received and generate results by comparing the same with the defined rules and/or data. The results generated are sent to the user access device (2) and/or stored by the data storage unit (53) in the analysis unit (5).

The image processing unit (51) in the analysis unit (5) is the unit that performs the recognition of texts, license plates, faces and certain objects by applying the defined image processing methods to the digital image data received from the communication interface (4). The image processing unit (51) identifies certain objects based on the defined object data stored therein. The image processing unit (51) stores the identified texts, license plates, objects and faces in the data storage unit (53) and runs queries based on the searched text, license plate, object and face data and determines the result by filtering the outcome according to certain rules. In an embodiment of the present invention, the analysis unit (5) communicates with the integrated database that contains the suspected individual, vehicle, object and text information and that is updated regularly, and queries the license plate and face data identified by the image processing unit (51) on the database containing suspected vehicle and face data. If the image processing unit (51) detects that the identified license plate and face match with a searched vehicle and face, the image processing unit (51) transmits certain data concerning the person and vehicle of interest to the user access device (2) via the communication interface (4) to be displayed to the authorized users. In an embodiment of the present invention, the image processing unit (51) categorizes the detected texts, objects, license plates and faces based on the defined criteria and transmits the same to the storage unit (53) to be stored therein. In an embodiment of the present invention, the image processing unit (51) detects, in addition to the license plate information, the color, brand, model and class information of the identified vehicles by associating to the location and temporal information and transmits the information to the data storage unit (53).

In an embodiment of the present invention, the image processing unit (51) determines the parking location and speed of the vehicles identified and the road condition, number of vehicles and the traffic flow rate based on the defined rules.

The detection unit (52) in the analysis unit (5) receives the sensor data collected by the sensor unit (32) and transmitted by the communication interface (4). The detection unit (52) evaluates the data received based on the definitions contained therein and determines whether there is an abnormal situation. The detection unit (52) detects abnormal situations by evaluating the sensor data received based on the defined upper and lower limit values. In an embodiment of the present invention, in location-dependent measurements such as sound measurement, the detection unit (52) analyses the sensor data received from more than one environment monitoring unit (3) and the associated location data and determines the location of the incident by combining the relative data.

In an embodiment of the present invention, the detection unit (52) measures the traffic flow rate and the number and the dimensions of the vehicles using the data received from the RaDAR units in the environment monitoring unit (3). In an embodiment of the present invention, the detection unit (52) categorizes the vehicles and dimensions thereof measured by tags such as motorcycle, truck and passenger car according to their dimensions.

The storage unit (53) in the system (1) of the present invention stores the evaluation results of the image processing unit (51) and the detection unit (52). The storage unit (53) stores the reference information necessary for the evaluation process. The storage unit (53) categorizes and stores the data identified and determined by the units in the analysis unit (5). The storage unit (53) associates the stored data with the location and temporal information.

The mapping unit (6) in the system (1) of the present invention is the unit that performs 3D mapping based on the data transmitted by the image capturing units in the environment monitoring unit (3). The mapping unit (6) receives the visual data of the camera (31) transmitted by the communication unit (4) together with the location information and the LiDAR data. The mapping unit (6) generates the 3D map for each location by combining the images received from the camera (31) and the LiDAR data. In an embodiment of the present invention, the environment monitoring unit (3) comprises the 360 degree panoramic camera (31) and performs the 3D mapping by using the data obtained by said camera (31), associates the same with the location and temporal information so as to be stored. In the preferred embodiment of the present invention, the mapping unit (6) is integrated with the GIS (Geographic Information Systems).

The mapping unit (6) is integrated with the user access device (2) and enables the user (K) to perform searches on the 3D map based on time and location, and to view the stored images of the corresponding time and location in 3D. In an embodiment of the present invention, the mapping unit (6) enables the user (K) to view the images tagged on the 3D city map with a location and time using VR (Virtual Reality) wearable devices.

In an embodiment of the present invention, the mapping unit (6) enables the user (K) to access by means of the user access device (2) and view the images of the 3D panoramic camera (31) in the environment monitoring unit (3) in real time.

By means of the system (1) of the present invention security is provided by scanning the residential areas such as cities by means of mobile units and analyzing the data obtained. The environment monitoring unit (3) in the system (1) of the present invention is mounted on the vehicles and objects such as police vehicles and garbage trucks that move around the city or that are stationary. The environment monitoring unit (3) that is mounted on the vehicles collects data by means of the units thereof in regions the vehicles pass, park or in regions where immobile or mobile objects on which the units are mounted are present, and transmits the collected data to the communication interface (4). The analysis unit (5) processes the visual and sensor data received from the communication interface (4) by means of the units thereof and enables the monitoring of the regions the vehicles pass, park or the regions where immobile or mobile objects on which the units are mounted are present. The image processing unit (51) of the analysis unit (5) identifies texts, license plates, objects and faces by processing the images received from the camera (31) in the environment monitoring unit (3). Furthermore, the image processing unit (51) determines the brands and models of the vehicles, the license plates of which are identified, and associates this information with the license plate information so as to be stored. The analysis unit (5) associates the evaluation results of the data with the location information and the time information received from the environment monitoring unit (3). Thus, if the user (K) runs a query in the stored data, results can be obtained based on time and location.

The system (1) of the present invention further comprises the mapping unit (6). The 3D mapping is realized by processing the image data received from the environment monitoring unit (3) and required for the 3D mapping and associating the same with the location information. The map of the locations of the moving vehicles and the stationary objects on which the environment monitoring unit (3) is mounted is continuously updated and the users are enabled to access up to date data of the residential areas.

Furthermore, in the system (1) of the present invention, by means of the user access device (2) the user (K) can access the stored evaluation results data and the 3D map data generated by the mapping unit (6), The user (K) may perform searches in the stored data based on texts, license plates, faces, objects, colors, locations and time or based on any criterion stored by the analysis unit (5) and the mapping unit (6). By means of a suitable interface, the user (K) is enabled to view the data transmitted to the user access device (2) as a result of the searches and the results based on the search criteria of the user (K) and comprehensive details related to the results. In the system (1) of the present invention, 3D images generated are compatible with virtual reality devices and the user (K) can investigate the residential area in 3D by moving forward or backward in time. By means of the system (1) of the present invention, measures against various threats can be taken and past incidents can be investigated by means of a comprehensive monitoring and analysis infrastructure.

A wide range of the embodiments of the system (1) of the present invention can be created and the present invention is not limited to the examples provided herein and the fundamental principles of present invention are disclosed in Claims.

1-25. (canceled)

26. A system that provides environmental monitoring by means of comprehensive and mobile units that comprise audio, radiation and chemical gas sensing units and that perform the recognition of texts, license plates, objects, colors and faces, comprising
at least one user access device in communication with the data network, with which the user (K) interacts, wherein
at least one environment monitoring unit disposed on the vehicles or objects for environmental monitoring and location detection and having at least one camera that detects images, at least one sensor unit with sensors thereon for measuring sounds, radiation, air pollution, chemical gasses, fog and weather conditions and at least one wireless communication device for transmitting the data received from the camera and the sensor unit to corresponding units via a data network,
at least one communication interface that receives the data by means of the wireless communication device and categorizes the same so as to send each data to the corresponding unit for processing and that receives the data sent to be transmitted to the user access device and transmits the same to the user access device via a data network,
at least one analysis unit that processes the data transmitted by the communication interface and that compares and stores the results,
at least one image processing unit that is disposed in the analysis unit and that executes the text, license plate, face and stored and defined object recognition functions by processing the visual data received from the camera,
at least one detection unit that is disposed in the analysis unit and that analyzes the sensor data received from the sensor unit and transmitted by the communication interface based on the defined rules,
at least one data storage unit that is disposed in the analysis unit and that stores the data with which the analysis results will be compared and the comparison results, and
at least one mapping unit that receives the digital data captured by the camera and the location data from the communication interface and that generates the 3D map of the city by processing the location information and the digital images received from different cameras.

27. A system as in claim 26, wherein the user access device that enables the data transmitted by the analysis unit and the mapping unit via the communication unit to be displayed to the user (K) by means of a suitable interface.

28. A system as in claim 27, wherein the environment monitoring unit that associates the data collected by the units contained therein with the location information detected by the environment monitoring unit and transmits the data to the communication interface.

29. A system as in any one of the above claims, wherein the environment monitoring unit comprising the RaDAR, the LiDAR and the 360 degree panoramic image sensors.

30. A system as in claim 29, wherein the environment monitoring unit that associates the data generated by the camera with the data received from the LiDAR sensors and sends the same together with the location information to the mapping unit via the communication interface in order to use the data generated by the camera in 3D mapping process.

31. A system as in claim 29, wherein the environment monitoring unit that transmits the data collected by the sensor unit and the location information to the detection unit via the communication interface.

32. A system as in claim 30, wherein the communication interface that transmits images captured by the camera to image processing unit in the analysis unit together with the location data, and to the mapping unit together with the LiDAR data and the location data.

33. A system as in claim 31, wherein the communication interface that transmits the sensor data collected by the sensor unit to the detection unit.

34. A system as in claim 32, wherein the image processing unit that runs queries of identified texts, license plates, objects and faces based on the text, license plate, object and face data stored in the data storage unit and evaluates the result.

35. A system as in claim 34, wherein the image processing unit that compares the identified license plates and faces with the license plates and faces in the databases integrated with the analysis unit that contain the information of suspected persons, vehicles, objects and texts.

36. A system as in claim 34, wherein the image processing unit that transmits the data concerning the person and vehicle of interest to the user access device via the communication interface to be displayed to the authorized users if the image processing unit detects that the identified license plate and face match with a suspected vehicle.

37. A system as in claim 36, wherein the image processing unit that categorizes the detected texts, license plates and faces based on the defined criteria and that transmits the same to the storage unit to be stored therein.

38. A system as in claim 37, wherein the image processing unit that detects, in addition to the license plate information, the color, brand, model and class information of the identified vehicles by associating to the location and temporal information and transmits the information to the storage unit.

39. A system as in claim 37, wherein the image processing unit that determines the parking location and the speed of the vehicles identified and the road condition, number of vehicles and the traffic flow rate based on the defined rules.

40. A system as in claim 33, wherein the detection unit that determines abnormal conditions by evaluating the data received based on the lower and upper limit definitions.

41. A system as in claim 40, wherein the detection unit that analyses the sensor data received from more than one environment monitoring unit and the associated location data and determines the location of the incident by combining the relative data in location-dependent measurements.

42. A system as in claim 41, wherein the detection unit that measures the traffic flow rate and the number and dimensions of the vehicles using the data received from the RaDAR units in the environment monitoring unit.

43. A system as in claim 42, wherein the detection unit that categorizes the vehicles, the dimensions of which are determined, according to the dimensions thereof.

44. A system as in claim 39, wherein the storage unit that enables the evaluation results of the image processing unit and the detection unit, the reference information necessary for the evaluation process and the data identified and determined by the units in the analysis unit to be categorized, to be associated with the location and time information and to be stored.

45. A system as in claim 34, wherein the mapping unit that receives the image data of the camera transmitted by the communication interface as well as the location data and the LiDAR data, and that generates location-based 3D maps by combining the camera images and the LiDAR data for each location.

46. A system as in claim 45, wherein the mapping unit that performs 3D mapping using the data transmitted by the environment monitoring unit comprising the 360 degree panoramic camera and that associates the same with the location and time information so as to be stored.

47. A system as in claim 45, wherein the mapping unit that is integrated with the GIS.

48. A system as in claim 46, wherein the mapping unit that enables the user (K) to perform searches on the 3D map based on time and location and to view the stored images of the corresponding time and location in 3D by means of the user access device.

49. A system as in claim 48, wherein the mapping unit that enables the user (K) to view the images tagged on the 3D city map with a location and time using VR wearable devices.

50. A system as in claim 48, wherein the mapping unit that enables the user (K) to access by means of the user access device and to view the images of the 3D panoramic camera in the environment monitoring unit in real time.
